(19) United States
(12) Patent Application Publication
(10) Pub. No.: US 2002/0196249 A1
(43) Pub. Date: Dec. 26, 2002

(54) System of processing and printing multidimensional and motion images from medical data sets

(76) Inventors: Paul F. Peters, Suwanee, GA (US); Jerry C. Nims, Atlanta, GA (US)

Correspondence Address: PATTON BOGGS LLP, ATTORNEYS AT LAW, 2550 M Street, NW, Washington, DC, 20037-1350, US

(21) Appl. No.: 10/176,116

(22) Filed: Jun. 21, 2002

Related U.S. Application Data
(60) Provisional application No. 60/299,414, filed on Jun. 21, 2001.

(51) Int. Cl. G06T 15/00

(52) U.S. Cl. 345/419

(57) ABSTRACT

Multiple images of a patient are obtained by one or more medical imaging apparatus. A plurality of the images are selected, interlaced with one another and printed on a lenticular media. Text may be input and combined with one or more of the selected images. The interlacing and printing are such that viewing the lenticular media from a succession of viewing angles provides a sequential spatial walk-through or time history of an image region of the patient. Images from two or more medical imaging apparatus may be overlaid to provide a sequence of multi-spectral images.

This application claims the benefit of U.S. Provisional Application No. 60/299,414, filed Jun. 21, 2001, which is hereby incorporated by reference.

### BACKGROUND OF THE INVENTION

1. Field of the Invention

This invention relates generally to lenticular three-dimensional and motion images and, more particularly, to a system of acquiring, processing, mapping and printing multiple images or specifically, frames of medical information onto a portable lenticular media for convenient, practical viewing of multiple angle, multi-spectral, sequential motion, flip, zoom, three-dimensional, and other medical information-carrying image sets without need for electronic assistance.

2. Related Art

Imagery has been used in medicine for more than a century. Early uses included daguerreotype photography of matter such as patients' visible symptoms and extracted tissues, for use in textbooks, manuals, journals and the like. Medical imagery has advanced to include, for example, chemical film X-ray, ultrasound imagery, positron emission tomography (PET), and magnetic resonance imagery (MRI). Modern medical practitioners, including physicians, nurses, and laboratory technicians, in almost every specialty, frequently employ a range of different image collection technologies for diagnosing and monitoring the condition of a patient. Multiple images may be obtained employing the same technology for each image. If this is done, the images may be from different viewing angles, under different lighting conditions, or at different amounts of zoom. Images may be collected over a period of time, to monitor and characterize the history of a condition. Different image collection technologies may be used to obtain images of different resolution quality, or to obtain images showing different aspects and manifestations of the underlying condition. The images may be stills and may be motion pictures. In addition, with technologies such as MRI, images may be obtained at one or more particular depths within the patient. Further, images may be obtained by, for example, MRI or Computer Aided Tomography (CAT) scans having information sufficient to characterize three-dimensional contours within a body.

Storing, retrieving and viewing the images, however, can present problems. One problem, which is for purposes of example and is not intended as limitation, can be seen from a typical task of viewing multiple X-ray images taken from, for example, different viewing angles. Such viewing is typically done by first placing hard copies of the X-ray images, typically transparencies, on a light rack, and looking at them side-by-side. When the physician is finished, or when a new set of images must be viewed, either for the same patient or another patient, the multiple X-rays are placed into, for example, a manila envelope and then put into a file. If a particular one, or subset, of the plurality of X-rays have remarkable features these may be marked as such with an adhesive sticker, a marker, and/or identified in the physician's write-up. The write-up may be handwriting which may or may not be entered into a computer accessible database. The write-up may require, or benefit from, the attending physician making note of the angle, and magnification, of the respective X-rays.

The above-described example illustrates shortcomings in the general existing art of viewing hard copies of conventional X-rays. One is that viewing the multiple hardcopy X-rays typically requires placing them side-by-side, typically on a light stand, and standing in front of the light stand for duration of the viewing. Another is that the multiple X-rays must be placed into a file, for later retrieval, and the order in which X-rays were arranged on the light stand may not be reflected by the order that they are placed into the file. Still another shortcoming is that identification of particular X-rays and their respective remarkable features must be created, and maintained, by placing or writing an identifier on the X-ray hardcopy, or by clear, unambiguous identifying information in the textual write-up generated by the physicians, or both. For the information contained in the X-rays to be later reviewed, such as during a patient follow-up consultation, the same or a different physician must read the original write-up, pull the set of X-rays from the file folder, perhaps select the X-rays of interest from the set, and then arrange them on a light stand to conform to, or make sense in comparison to, the write-up.

Ultrasound images may be viewed, marked on and described in writeups in a manner similar, in many respects, to the above example sequence of a typical X-ray viewing session.

Photographic images, both conventional film and digital, are also used in the medical sciences. Example medical fields employing photographic images include, but are not limited to, dermatology and plastic surgery. Photographs may be obtained in the visible spectrum, as well as infrared (IR) and ultraviolet (UV). For example, a dermatologist may take both a visible wavelength picture and an IR picture of a skin region, for demonstrative as well as diagnostic reasons. As known in the dermatology field, certain conditions exhibit particular features under particular wavelengths of light. It is also known in the dermatology field to construct a photographic history of a skin area, to show, for example, either a development of a disease or its response to medication. Still further, medical textbooks, journals, research publications, and private research efforts may collect representative photographs from a large sample set of patients to show, for example, guidelines for the differential diagnosis of skin disorders. Such pictures may be published as a descriptive article with an array of photographs having captions such as, for example, “early stage melanoma, upper arm, 45 year old Caucasian male, 3 mm diameter.”

There are problems and shortcomings with these techniques. For example, when a dermatologist collects a plurality of photographs of a skin area, either as a time history or as a multi-spectral image set, or both, he or she must mark the pictures, or describe them in the patient write-up for later reference. This can be burdensome and prone to error and other loss over time. If the pictures form a time history the documentation and indexing requirements are increased. If a set of pictures are obtained from two or spectral bands, such as visible light and IR, the documentation is likewise burdensome.

One solution to the above-identified problems is to scan the pictures, or X-ray images, convert them into digital files, and then input and store the files in a computer-accessible database. However, retrieving and viewing the images requires the user to have access to the database, and to have visual display, such as a liquid crystal display (LCD) or cathode ray tube (CRT) display connected to the access device. Therefore, although this may be a partial solution, it lacks a significant benefit of the existing art of hard copy viewing, namely the ability to hand-carry a copy, or put a copy in a notebook or briefcase from which it can be easily retrieved and viewed.

PET, CAT, and MRI images are typically obtained for a given volumetric region within a patient. PET imaging may also be time-based, meaning that the volumetric images are obtained over a particular time period of interest, such as after injecting the subject with a radiolabeled biologically active compound, typically termed a “tracer.” The techniques and principles of operation of PET scanning are well-known and are thoroughly described in the available literature. See, for example, Mazziota, J. and Gilman, S., Eds., Clinical Brain Imaging: Principles and Applications, 1992, F.A. Davis Company, pp 71-107. Common to PET, CAT and MRI is that the image data is necessarily computed by a digital computer. Display is typically by a CRT or LCD connected to the computer system on which the image was computed or to shared database. Since each of the PET, CAT and MRI methods have information describing a three-dimensional volume by volumetric pixels, or “voxels”, the CRT or LCD allows the user to “walk-through” the image, slice-by-slice, along any viewing axis. Hard copies may be required, though, and this is typically accomplished by using a conventional printer connected to the computer resource generating the CRT or LCD image, by which the user prints a “screen shot” when he or she wishes to a copy of a particular image of interest.

There are shortcomings with the above-described methods of viewing PET, CAT and MRI images. One is that a “walk-through” requires a computer resource having an LCD or CRT, and requires that the resource be connected to the database on which the image is stored. Another is that the hard copies, since they are generated by a conventional printer, are a single, two-dimensional image. As a result, a slice-by-slice “walk-through” can only be generated by two methods. One is to print a plurality of hard copies, and the viewer later peruses through these to recreate the “walk-through.” Another is to reduce the size of the images and then print them side-by-side in a tile arrangement. The latter method has additional shortcomings, though. One is that the images are necessarily reduced in size. The reduction has a secondary effect in that captions, axis labels and other text may be so reduced as to be unreadable. Another shortcoming is that the comparison of images is, at best, side-by-side. Although a side-by-side, or same page view may sometimes suffice, there are likely instances in which an overlay comparison such as that provided by a “click by click” walk-through using a computer display will emphasize. The existing methods for viewing a PET image time history of a particular slice have substantially the same shortcomings as described for slice-by-slice walkthroughs.

### SUMMARY OF THE INVENTION

The present invention The present invention advances the art and helps to overcome the aforementioned problems shortcomings by providing a portable, passive, image display medium in which multiple medical images are fixed for selective viewing, including sequential viewing, slice-by-slice in spatial coordinates, periodic time sample images, and multi-spectral images, with associated textual description, with a two-dimensional or three-dimensional appearance.

A first aspect of the invention includes a digital data processing system having a digital data processor resource, a program storage resource, and a data storage resource interconnected with one another. A lenticular data, representing physical properties of a lenticular medium is input to the digital processing system. A printer data is also input into the digital processing system, the printer data representing properties of the printer resource. Examples include the resolution in dots per inch. Next a first digital image file is input into said data storage resource, said first digital image file representing a first visible image of a patient. Likewise, a second digital image file is input into the digital data storage resource, the second digital image file representing a second visible image of a patient. Next, the first digital image file and the second digital image file are interlaced into a rasterized interlaced data file, the interlacing preferably performed by the digital data processor resource in accordance with the lenticular data and the printer data.

The rasterized interlaced data file, or data based on or representing the rasterized interlaced data file is then output to the printer resource and an interlaced image corresponding to the interlaced data file printed onto a lenticular medium. The interlaced image has a first image corresponding to the first digital image file which is interlaced with a second image corresponding to the second digital image file, The lenticular medium is preferably a transparent sheet having a plurality of microlenses disposed on at least one surface. The interlacing and printing are performed such that a first observable image focuses on the eyes of an observer located at a first viewing position relative to the lenticular medium and a second observable image focuses on the eyes of an observer located at a second viewing position relative to the lenticular medium. The first observable image corresponds to the first digital image file and the second observable image corresponds to the second digital image file.

Another aspect further includes inputting into the digital processing system a first image descriptor data and a second image descriptor data representing, respectively, an information associated with the first visible image and an information associated with the second visible image. According to this aspect the interlacing inserts a first rasterized information image and a second rasterized image into the rasterized interlaced data file, the first rasterized information image corresponding to the first image descriptor data and the second rasterized information image corresponding to the second image descriptor data. The interlacing and printing are performed such the first observable image includes a visible image corresponding to the first rasterized information image and representing at least a portion of the first image descriptor data. Likewise, the second observable image includes a visible image corresponding to the second rasterized information image and representing at least a portion of the second image descriptor data.

A further feature, which may be in combination with the above-summarized first and second image descriptor data aspect, is the first visible image representing a visible feature of an area of a patient obtained at a first time and the second visible image represents a visible feature of said area of the patient obtained at a second time. In such a combination the first image descriptor data may include a data at least partially identifying the first time and the second image descriptor data includes a data at least partially identifying said second time.

A still further feature, which may be in combination with the above-summarized first and second image descriptor data aspect, and in combination with the above-summarized first and second time feature, is the first visible image representing a visible feature of an area of a patient obtained from a first observational position and the second visible image represents an image of the region of the patient obtained from a second observational position. In such a combination the first image descriptor data may include a data at least partially identifying the first observational position and the second image descriptor data may include a data at least partially identifying the second time observational position.

Another feature, which may be in combination with the above-summarized first and second image descriptor data aspect, and in combination with the above-summarized first and second time feature, is the first visible image representing an image of an area of a patient obtained from a first energy radiation type and the second visible image represents an image of the region of the patient obtained from a second radiation type. In such a combination the first image descriptor data may include a data at least partially identifying the first radiation type and the second image descriptor data may include a data at least partially identifying the second radiation type.

Still another feature, which may be in combination with the above-summarized first and second image descriptor data aspect, and in combination with the above-summarized first and second time feature, is the first visible image representing an image of an planar slice of a patient obtained from a first energy radiation type overlaid by an image of the same region of the patient obtained from a second radiation type, the planar slice being within a first depth. The second visible image representing an image of another planar slice, laterally aligned with the first visible image but taken at a second depth, again being an image of a first energy radiation type overlaid by an image of the same slice of obtained from a second radiation type.

These and other aspects and features, and their respective benefits and advantages will become more apparent to, and better understood by, those skilled in the relevant art from the following more detailed description of the preferred embodiments of the invention taken with reference to the accompanying drawings, in which like features are identified by like reference numerals.

### BRIEF DESCRIPTION OF THE DRAWINGS

FIG. 1 shows an example high-level functional flowchart illustrating an example operation of a general aspect of the invention;

FIGS. 2A through 2F shows a first example multi-view lenticular medical image generated in accordance with a time history aspect of the invention, as seen from a succession of six viewing angles; and

FIGS. 3A and 3B shows a second example multi-view lenticular image generated in accordance with a multi-spectral overlay aspect pf the invention, as seen from a succession of two viewing angles.

### DETAILED DESCRIPTION OF THE INVENTION

A first aspect of the invention may be carried out on an example system including a medical imaging apparatus (not shown) such as, for example, a Siemens™ ECAT 921 PET camera obtaining images of, for example, glucose metabolism, and a digital data processing system (not shown) having a digital data processor resource, a program storage resource, and a data storage resource interconnected with one another. For this example, standard Siemens™ software reconstructs and reslices the PET pictures, or studies. Other medical imaging equipment contains similar software, as is known in the art. The particular digital data processing system is not germane to the invention. The processing requirements that it must meet are simply the necessary computations for generating the original images, and the further steps in accordance with the invention as described below. The processing burdens are in part dependent on the particular imaging technology, e.g., PET and MRI imaging requires substantial computations, while a convention still-frame X-ray imaging apparatus requires significantly less. The selection of the digital data processing system is readily performed upon reading this disclosure by one of ordinary skill in the art of designing medical imaging apparatus. An example digital data system is a standard off-the-shelf personal computer such as a Dell Optiplex® having a Pentium III or equivalent microprocessor-based personal computer running under, for example, the Windows 2000®, UNIX®, Apple OSX®, or, or equivalent operating system.

A PET scanner being the example medical imaging apparatus is not a limitation. The operation with respect to depth slices is substantially the same if an MRI or CAT scanner is substituted. The interconnection among the components of the digital processing system may be direct, through a local area network (LAN), or through the Internet or other wide-area network in accordance with known principles of distributed computing systems.

A printer resource, preferably an inkjet printer, is connected to the digital data processing system. An example is an Epson®760 inkjet printer.

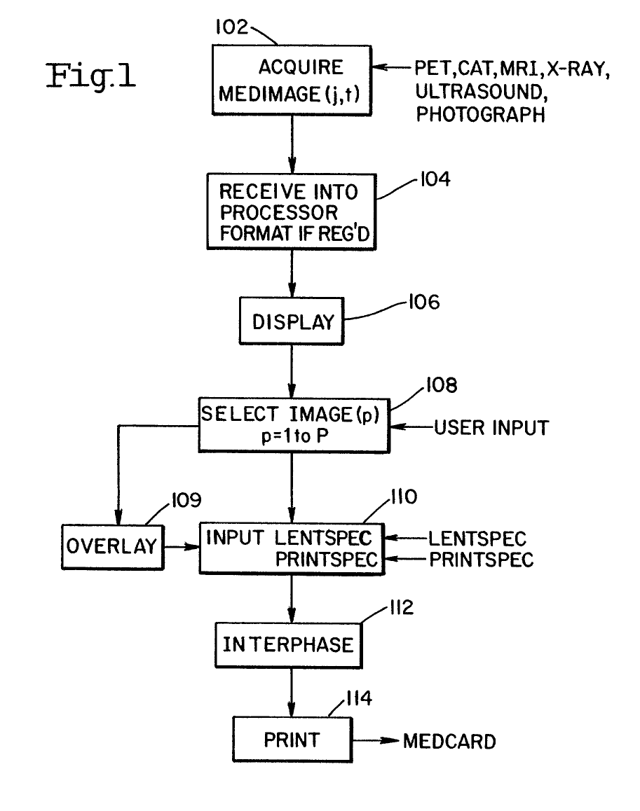

FIG. 1 shows an example high-level functional flowchart illustrating an example operation of a general aspect of the invention. The particular breakdown into blocks shown by FIG. 1 is an example selected for purposes of describing the operation of the invention. The breakdown is not a limitation on the software modules or objects that a person of ordinary skill could generate to perform the described functions. Depending on design choice some of the blocks could be merged into a single operation, while others could be further segmented. Further, unless otherwise stated, or clearly understood from the context, the ordering of the FIG. 1 blocks, and the word “next” in the referencing description, is not intended as a limitation on the time order in which operations are performed.

Referring to FIG. 1, step 102 acquires an image MEDIMAGE(j,t) file from a patient. Step 102 utilizes a digital processing resource connected to, or integral with the PET scanner. For this example the index “j” represents the depth, or “slice” and the index (t) represents time, with j=1 to S, and t=1 to N, where S is the number of slices and N is the number of frames. These are example indices used for only for describing an example operation of the invention. Other indices and image identifier names known in the art may be used. Step 104 receives the MEDIMAGE(j,t) medical image file into the digital data processing system. Step 104 would, if necessary, convert the file to .psd format. Each slice of the MEDIMAGE(j,t) is at RES input resolution, where RES is in dots per inch (dpi). An example file is N=eight (8), S=seventeen (17), and RES=seventy-two (72) dpi.

Step 106 displays the MEDIMAGE(j,t) file on, for example, the cathode ray tube (CRT) or liquid crystal display (LCD) of the digital data processing system. An example software for displaying the MEDIMAGE(j,t) file in a viewable sequence is the Emory Cardiac Toolbox™, SPECT (Single Positron Emission Computer Tomography) Processing software.

Next, at step 108, the user selects a plurality of P images, labeled for reference as IMAGE(p), p=1 to P, from the MEDIMAGE(j,t) file for viewing on hardcopy. For example, the user may wish a hardcopy view of five slices for a particular time t. Assigning the selected time as K, the user would retrieve the eight slices by entering eight corresponding index values for j into MEDIMAGE(j,K). Alternatively, the user may wish to select a plurality of P images representing a time history of images for a particular jth slice. For example, in a cardiology study employing PET kinetic imaging of N-13 ammonia activity, the user may wish a successive display of the N-13 activity, over a particular time duration, for a particular Lth slice of the patient's heart. The user would then identify the t index values for the desired sample times and select the desired images as MEDIMAGE(L, t).

After selecting the P images for IMAGE(p), p=1 to P, the user enters “OK” or “done” or an equivalent user interface input (not shown), whereupon the digital processing system goes to step 110 and asks for PRINTSPEC data describing the resolution of the inkjet printer (not shown) and LENTSPEC data describing the lenses-per-inch (LPI) of the lenticular medium (not shown), and its dimensions. An example LPI is sixty and an example dimension is eight and one half inches by eleven inches. Optionally, step 108 includes the user entering text description to accompany one or more of the P selected images. The text entry could be in accordance with the general image caption text entry as known in the graphical computer arts. For text is referenced herein as TEXT(p), for p=1 to P. The text entry may augment text (not shown) and graph axes (not shown) included with the MEDIMAGE,t) images generated by, for this example, the Siemens® PET ECAT 021 scanner.

Step 112 then interphases, i.e., merges, the selected slices into one merged medical image file MFILE. The merging rasterizes each of the slices and interlaces the raster line, in accordance with the LENTSPEC data, in accordance with the description in co-pending U.S. application Ser. No. 09/616,070, which is hereby incorporated by reference.

As stated above, the ordering of the FIG. 1 blocks is not intended as a limitation on the time order in which operations are performed. For example, the block 112 interphasing or interlacing operation is based in part on the PRINTSPEC date characterizing the particular printer being used, and the LENTSPEC characterizing the particular lenticular media. FIG. 1 block 110 shows the entering of the PRINTSPEC data and LENTDATA data or the lenticular data as immediately preceding step 112. However, the PRINTSPEC data and the LENTDATA could be prestored as, for example, default values which would require step 110 only upon an edit request by the user.

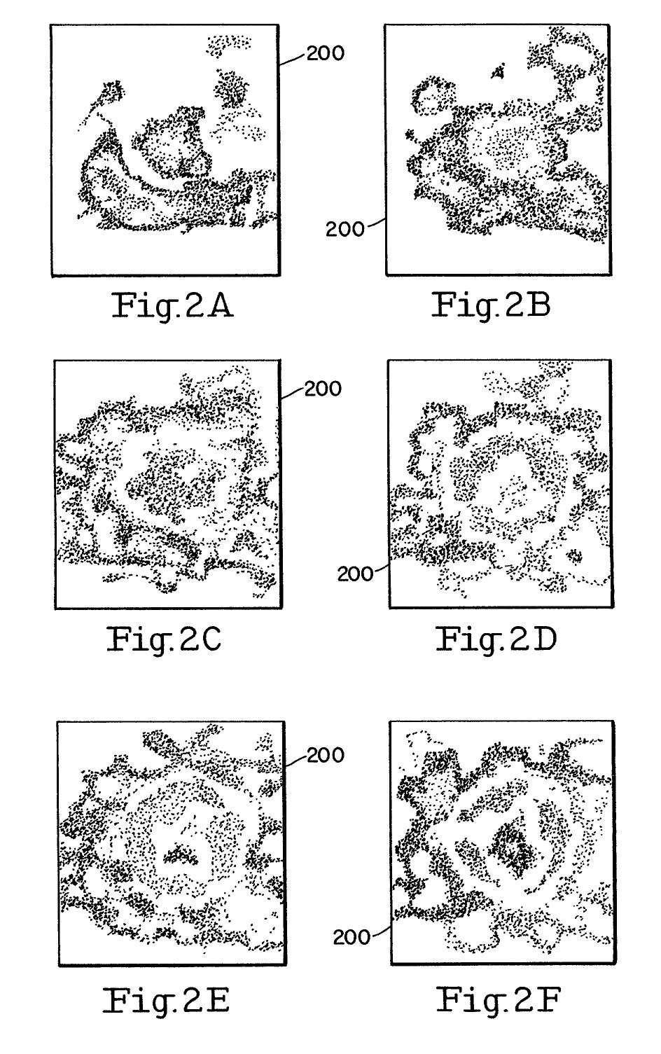

Step 114 then outputs, or prints, the merged file MFILE, preferably through an inkjet printer, onto either the ink-receptive backside of a lenticular sheet or to a substrate which is then laminated to a lenticular sheet, to form a final card/printout, termed herein as a MEDCARD, or an Orasee Medial Image Display Acquisitions, or OMIDA™, card at step 112. FIGS. 2A through 2F show an example MEDCARD, labeled as 200. As identified above, an example inkjet printer is an Epson 980. The printing operation, and the selection of the lenticules, is in accordance with co-pending U.S. application Ser. No. 09/616,070.

An example MEDCARD 200 size at step 114 is four (4) inches x five (5) inches, and is twenty-two (22) mils in thickness. The MEDCARD 200 is then carried, for example, on the person and displayed to augment medical records, or when medical records are not available.

FIGS. 2A through 2F show an example MEDCARD 200 for P=6, viewed through a succession of six viewing angles, where the six images of IMAGE(p) correspond to an N-13 ammonia myocardial scan acquired over approximately three minutes. Each image represents counts acquired over ten seconds. FIG. 2A is the image at t=25 seconds, while FIGS. 2B through 2F show the image as acquired at 35, 55, 75, 85 and 115 seconds. The optical mechanism by which the six images are seen is described in co-pending U.S. application Ser. No. 09/616,070.

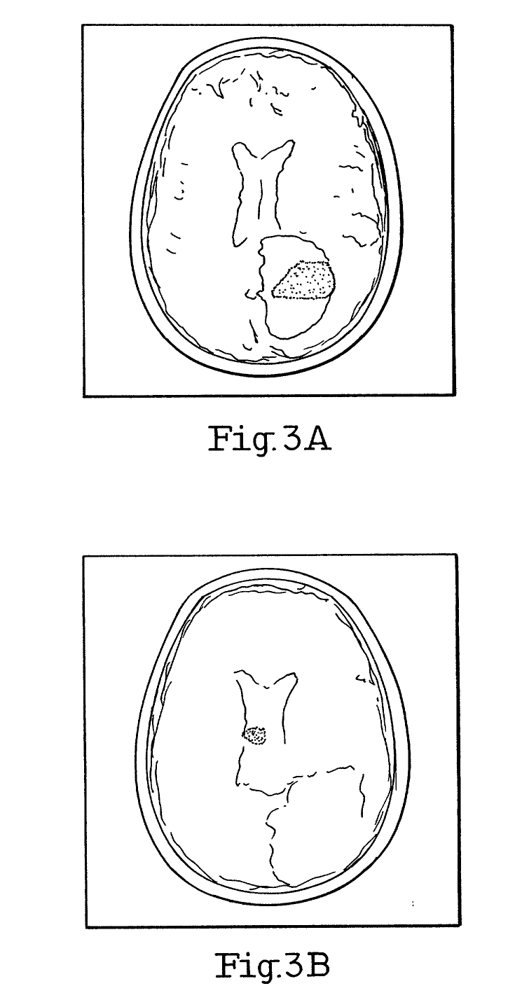

Referring to FIG. 1, an other aspect of the invention includes obtaining images from a first type of medical imaging scanner and the images from a second type of medical imaging scanner, and then overlaying these to form the IMAGE(p) images. The overlaying step is shown as 109. An example first medical imaging scanner is a PET scanner as described above, and an example second medical imaging scanner is an MRI scanner. An example operation according to this aspect of the invention is a brain scan providing an S slice MRI view and an S slice PET view of a patient's brain. As known in the neurological sciences, an MRI scan typically shows significantly higher resolution and contrast than a PET scan. However, certain tumors undetectable by MRI may be detectable by a PET scan. Therefore, overlaying the PET images with the MRO images in, for example, a slice-by-slice manner, may provide diagnostic abilities not available with either technology alone. This aspect of the present invention permits ready, portable viewing of such overlaid images. An example is shown by FIGS. 3A and 3B. FIG. 3A shows an overlay of an MRI image and a PET image, at a particular depth slice. The region labeled TM is a tumor, showing as a remarkable PET image feature, which did not readily appear in the MRI image within the overlay. The PET image, though, did not provide clear detail as to the location of the TM feature. Overlaying the PET and MRI image allowed the TN feature to be seen, and to be localized, within the same image. FIG. 3B is an adjacent slice image of he same patient, also an overlay of MRI and PET, but into which the tumor does not appear to have spread. Therefore, rotating the MEDCARD 200 through a succession of viewing angles, the user can see the lateral and depth characteristics of the tumor. The MEDCARD 200 generated according to this feature of the invention thus provides a portable, inexpensive, multi-spectral “walk-through” of the patient's brain, or other organ, without requiring a computer or other powered viewing device.

It should be understood that normalization and registration of the MRI images and the PET images may be required. These operations are readily performed using off-the-shelf medical imaging software available from, Siemens, General Electric, and other vendors.

The example described in reference to FIGS. 3A and 3B is a slice-by-slice walk through for a particular, fixed time sample. The same operation may be sued for a multi-spectral time history of one or more slices.

In an example application of the invention a recovering stroke victim would carry on his/her person a MEDCARD 200 replicating images collected from the, MRI, CAT, PET, or ultrasound scan. Entered as TEXT(p) may be information regarding the patient. Further, the MEDCARD 200 could be attached to, or integrated with a “smart card” having other data regarding the patient. Even further, one or more security-type features may be combined within the images displayed by the MEDCARD 200. A benefit is that if the patient were to travel outside of his or her home area, the patient could produce the MEDCARD 200 to medical personnel otherwise unfamiliar with the patient.

While the present invention has been disclosed with reference to certain preferred embodiments, these should not be considered to limit the present invention. One skilled in the art will readily recognize that variations of these embodiments are possible, each falling within the scope of the invention, as set forth in the claims below.

we claim:

1. A method for displaying images of a patient comprising:
providing a digital data processing system having a digital data processor resource, a program storage resource, and a data storage resource interconnected with one another;
providing a printer resource connected to the digital data processing system;
inputting a lenticular data into said digital processing system, said lenticular data representing physical properties of a lenticular medium;
inputting a printer data into said digital processing system, said printer data representing properties of said printer resource;
inputting a first digital image file into said data storage resource, said first digital image file representing a first visible image of a patient;
inputting a second digital image file into said digital data storage resource, said second digital image file representing a second visible image of a patient;
interlacing the first digital image file and the second digital image file into a rasterized interlaced data file, said interlacing performed by said digital data processor resource, in accordance with said lenticular data and said printer data;
outputting said rasterized interlaced data file to said printer resource;
printing, on said printer resource, onto a lenticular medium, an interlaced image corresponding to said interlaced data file, said lenticular medium having a transparent sheet and a plurality of microlenses disposed on at least one surface, and said interlaced image having a first image corresponding to said first digital image file interlaced with a second image corresponding to said second digital image file,
wherein said interlacing and said printing are performed such a first observable image focuses on the eyes of an observer located at a first viewing position relative to said lenticular medium and a second observable image focuses on the eyes of an observer located at a second viewing position relative to said lenticular medium, said first observable image corresponding to said first digital image file and said second observable image corresponding to said second digital image file.

2. A method according to claim 1, further comprising:
inputting into said digital processing system a first image descriptor data and a second image descriptor data representing, respectively, an information associated with said first visible image and an information associated with said second image, wherein said interlacing inserts a first rasterized information image and a second rasterized image into said rasterized interlaced data file, said first rasterized information image corresponding to said first image descriptor data and said second rasterized information image corresponding to said second image descriptor data, and wherein said wherein said interlacing and said printing are performed such said first observable image includes a visible image corresponding to said first rasterized information image and representing at least a portion of said first image descriptor data and said second observable image includes a visible image corresponding to said second rasterized information image and representing at least a portion of said second image descriptor data.

3. A method according to claim 1 wherein said first visible image represents a visible feature of an area of a patient obtained at a first time and said second visible image represents a visible feature of said area of said patient obtained at a second time.

4. A method according to claim 2 wherein said first visible image represents a visible feature of an area of a patient obtained at a first time and said second visible image represents a visible feature of said area of said patient obtained at a second time, and wherein said first image descriptor data includes a data at least partially identifying said first time and said second image descriptor data includes a data at least partially identifying said second time.

5. A method according to claim 2 wherein said first visible image represents X-ray image of a region of a patient obtained at a first time and said second visible image represents an X-ray image of said region of said patient obtained at a second time, and wherein said first image descriptor data includes a data at least partially identifying said first time and said second image descriptor data includes a data at least partially identifying said second time.

6. A method according to claim 2 wherein said first visible image represents an image of a region of a patient obtained from a first observational position and said second visible image represents an image of said region of said patient obtained from a second observational point, and wherein said first image descriptor data includes a data at least partially identifying said first observational and said second image descriptor data includes a data at least partially identifying said second time.

7. A method according to claim 2 wherein said first visible image represents a radiation pattern of a region of a patient of a first energy type, and the second visible image represents a radiation pattern of a region of a patient of a second energy type, and wherein said first image descriptor data includes a data at least partially identifying said first energy type and said second image descriptor data includes a data at least partially identifying said second energy type.

8. A method according to claim 7 wherein said first energy type is an X-ray and said second energy type is a magnetic resonance imaging radiation.

9. A method according to claim 7 wherein said first energy type is an X-ray and said second energy type is optical energy within the visible spectrum.

10. A method according to claim 8 further comprising registering said first visible image with said first visible image, wherein said registering, said interlacing and said printing are performed such that said first observable image appears to an observer located at said first viewing position to be at substantially the same position, and aligned with, the second observable image as it appears to the observer located at said second viewing position.
